(19) United States
(12) Patent Application Publication
(10) Pub. No.: US 2026/0101223 A1
(43) Pub. Date: Apr. 9, 2026

(54) METHOD FOR MANAGING REFERENCE SIGNAL TRANSMISSIONS IN A WIRELESS SYSTEM

(71) Applicants: CENTRE OF EXCELLENCE IN WIRELESS TECHNOLOGY, Chennai Tamil Nadu (IN); INDIAN INSTITUTE OF TECHNOLOGY MADRAS (IIT MADRAS), Chennai (IN)

(72) Inventors: Abhay Mohan Mahadevathupanthal Variyam, Chennai Tamil Nadu (IN); Dhivagar Baskaran, Chennai Tamil Nadu (IN); Pardhasarathy Jyothi, Chennai Tamil Nadu (IN); Jeniston Deviraj Klutto Milleth, Chennai Tamil Nadu (IN); Bhaskar Ramamurthi, Chennai Tamil Nadu (IN)

(21) Appl. No.: 19/349,431

(22) Filed: Oct. 3, 2025

(30) Foreign Application Priority Data
Oct. 4, 2024 (IN) 202441075341

(51) Int. Cl. H04W 24/10; H04L 1/1829; H04W 72/11

(52) U.S. Cl. CPC H04W 24/10; H04L 1/1829; H04W 72/11

(57) ABSTRACT

The present disclosure discloses methods for reducing the reference signal (RS) density for future wireless systems. The method comprising The method comprising receiving, by the UE, a plurality of configuration parameters for a first reference signal transmitted using a plurality of active ports and a second reference signal transmitted on a subset of active ports, wherein the plurality of configuration parameters comprising at least one of a performance metric, a criteria for performance monitoring, and configuration settings for the first reference signal and the second reference signal, receiving, by the UE, at least one of the first reference signal and the second reference signal in a first transmission occasion of the base station, determining, by the UE, the performance metric based on the at least one received reference signal, monitoring, by the UE, the performance metric to determine if the criteria for the performance monitoring is satisfied, and transmitting, by the UE, a feedback message based on the criteria for the performance monitoring.

### FIELD OF THE INVENTION

The present disclosure generally relates to wireless communication and particularly to methods and procedures for reduced reference signal density scheme.

### BACKGROUND

The new radio (NR) specification defines different reference signal (RS) for different purpose like demodulation reference signal (DMRS) for providing channel estimates to enable demodulation of data and channel state information reference signal (CSI-RS) and sounding reference signal (SRS) for channel state information (CSI) estimation. The process of ‘channel estimation’ involves initial estimation, along with interpolation and extrapolation of the estimates as and when required.

Ports for a RS refer to logical entities that node 1 and node 2 use to identify and process the RS. In the downlink, node 1 is the network and node 2 is the user equipment (UE), while in the uplink node 1 is the UE and node 2 is the network. Each port corresponds to a specific channel or spatial layer through which the RS is transmitted. These ports indicate distinct paths for signal transmission. As per the 5G NR definition, “an antenna port is defined such that the channel over which a symbol on the antenna port is conveyed may be inferred from the channel over which another symbol on the same antenna port is conveyed”.

A signal transmitted through a particular port may have certain large-scale channel properties in common with a signal transmitted through another port. In such cases, the two ports are said to be quasi-co-located (QCL). For example, a DM-RS may inherit the delay spread calculated from a QCL'ed CSI-RS. The parameters that are inherited in such a fashion are determined at least by the type of QCL relation as defined in the NR specifications. These QCL relations are configured in the UE by the network a.k.a. next-generation node-B (gNB) using transmission configuration indicator (TCI) states. It should be noted that the usage of the term gNB is for the ease in mapping its functionality to existing 5G systems. Its usage should not be constructed as limiting this invention in any way to the 5G framework.

The RSs in 5G NR are often configured to repeat the transmission in a periodic fashion. However, the recent trends in standardization are moving towards reduction of any periodic phenomenon to improve resource utilization efficiency. The new paradigm leans towards event-driven procedures necessitates a re-evaluation of the existing periodic RSs defined for 5G. Specifically, there is a need to make the RSs ‘on-demand’—i.e., the RSs will be transmitted only when the UE requests to transmit them and/or when the gNB decides to transmit them. When transmitted on a physical channel, it may choose to transmit the same RS with same resource utilization or completely skip the RS transmission or transmit another RS with a lower resource utilization in some transmission occasions. The resources freed up in the latter two cases may be used for transmitting additional data or to add redundancy for error control coding or control signaling through the physical channels. of the wireless channel due to mobility of the transmitter or receiver or the environment.

Therefore, there is a need for such a system that requires a way to identify the need to transmit the full-density RS either at the UE or at the gNB. This in turn requires careful monitoring of one or more performance metrics (or simply, ‘metrics’ in the context of this disclosure) of the system even while improving the channel estimation using the channel estimates of the past instances. The monitoring will require a new RS, but this RS can be designed to be efficient resource utilization with lower density required to enable the above functionality.

### OBJECT OF THE INVENTION

It is a general object of the present disclosure to provide methods and apparatuses for reducing reference signal density.

It is an object of the present disclosure to provide method and apparatus to transmit a demand-based RS density for estimating and monitoring the performance.

It is an object of the present disclosure to improve the already estimated channel state information (CSI).

It is an object of the present disclosure to provide techniques for dynamic selection of RS types based on performance metrics to reduce pilot overhead, thereby freeing up resources for either data transmission or transmitting other necessary signals.

### SUMMARY

The present disclosure provides methods and apparatuses for reducing the RS density for future wireless systems. A demand-based higher density RS (RS1) transmission and lower density RS (RS2) for estimating and/or monitoring the performance or improving the already estimated CSI.

In an embodiment, a method, performed by a user equipment (UE), for managing downlink reference signal transmission in a wireless system is disclosed. The method comprising receiving, by the UE, a plurality of configuration parameters for a first reference signal transmitted using a plurality of active ports and a second reference signal transmitted on a subset of active ports, wherein the plurality of configuration parameters comprising at least one of a performance metric, a criteria for performance monitoring, and configuration settings for the first reference signal and the second reference signal, receiving, by the UE, at least one of the first reference signal and the second reference signal in a first transmission occasion of the base station, determining, by the UE, the performance metric based on the at least one received reference signal, monitoring, by the UE, the performance metric to determine if the criteria for the performance monitoring is satisfied, and transmitting, by the UE, a feedback message based on the criteria for the performance monitoring.

In one aspect, wherein the performance metric is determined periodically or based on one or more transmission occasions.

In one aspect, the method further comprising transmitting, by the UE, the performance metric or a function of the performance metric.

In one aspect, the further comprising receiving, by the UE, at least one of the first reference signal, the second reference signal, or not receiving any reference signal in the subsequent transmission occasion, wherein the first reference signal, the second reference signal, or not receiving any reference signal are received based on one of the reported performance metric or a request in the feedback message, and performing, using the received reference signal, at least one of channel estimation, data demodulation, control information processing, and computing the performance metric.

In one aspect, wherein the configuration settings include at least one of a scheduling and CSI acquisition using a CSI-RS.

In one aspect, wherein the scheduling and CSI acquisition are based on one of a request or a report.

In one aspect, wherein the scheduling is one of a downlink dynamic scheduling, downlink semi-persistent scheduling, and downlink multi-slot scheduling.

In one aspect, the method further comprising: determining, based on configuration settings, whether the first reference signal and the second reference signal are scheduled as one of semi-persistent and multi-slot, triggering lower-layer activation for initial signaling, and receiving a configured pattern of the first reference signal and the second reference signal along with the downlink reception.

In one aspect, wherein monitoring the performance at the UE comprises monitoring the performance metric indicative of a time-variation of the channel, such as a channel quality estimate, an outcome of the CRC check, a number of HARQ retransmissions, or a quality of the LLR.

In one aspect, wherein a request or report contained in a feedback message is transmitted using a low-layer uplink channel.

In one aspect, wherein the request-based downlink semi-persistent scheduling (SPS) comprises receiving, by the UE, a scheduling grant comprising a first pattern of the first reference signal and the second reference signal, receiving, by the UE, an SPS activation signal, receiving, by the UE, plurality of data channels with a configured SPS periodicity in the first transmission occasion, determining, by the UE, the association between the plurality of data channels and at least one of the first reference signal and the second reference signal based on the pattern, performing at least one of channel estimation, data demodulation, and computing the performance metric; and transmitting, by the UE, a request for a scheduling grant comprising a second pattern of the first reference signal and the second reference signal based on the performance metric criterion.

In one aspect, the method further comprising receiving, by the UE, an SPS activation signal, and receiving the second pattern of the first reference signal and the second reference signal.

In one aspect, wherein the request-based downlink multi-slot (MS) scheduling comprises receiving, by the UE, an MS scheduling grant comprising a first pattern of the first reference signal and the second reference signal, receiving, by the UE, an MS activation signal, receiving, by the UE, a plurality of data channels in a first MS transmission occasion, determining, by the UE, an association between the plurality of data channels and at least one of the first reference signal and the second reference signal based on the pattern, performing at least one of channel estimation, data demodulation, and computing the performance metric, and transmitting, by the UE, a request for an MS grant comprising a second pattern of the first reference signal and the second reference signal based on the performance metric criterion.

In one aspect, wherein the request is transmitted using low-layer uplink feedback.

In one aspect, the method further comprising receiving, by the UE, an MS activation signal for a subsequent MS transmission, and receiving the second pattern of the first reference signal and the second reference signal.

In one aspect, wherein the report-based downlink MS scheduling comprises receiving, by the UE, an MS scheduling grant comprising a first pattern of the first reference signal and the second reference signal, receiving, by the UE, an MS activation signal, receiving, by the UE, a plurality of data channels in a first MS transmission occasion, determining, by the UE, an association between the plurality of data channels and at least one of the first reference signal and the second reference signal based on the pattern, performing at least one of channel estimation, data demodulation, and computing the performance metric; and reporting, by the UE, the performance metric.

In one aspect, the method further comprising receiving, by the UE, an MS activation signal for a subsequent transmission, and receiving the second pattern of the first reference signal and the second reference signal.

In one aspect, wherein the request-based CSI acquisition comprises receiving, by the UE, one of the first reference signal and the second reference signal, generating, by the UE, a CSI report based on CSI parameters, determining, by the UE, a performance metric based on one of the first reference signal and the second reference signal, requesting one of the first reference signal and the second reference signal for a subsequent reference signal reception, wherein the request is based on the performance metric, and transmitting, by the UE, the CSI report and the request.

In one aspect, the method further comprising receiving one of the first reference signal, the second reference signal, or no reference signal in a subsequent reception occasion in response to the transmitted request.

In one aspect, wherein the request is transmitted explicitly or implicitly based on the CSI report.

In one aspect, wherein the report-based CSI acquisition comprises receiving, by the UE, one of the first reference signal and the second reference signal, generating, by the UE, a CSI report based on CSI parameters, determining, by the UE, a performance metric based on one of the first reference signal and the second reference signal, and transmitting, by the UE, the CSI report and the performance metric.

In one aspect, the method further comprising receiving, by the UE, one of the first reference signal, the second reference signal, or no reference signal, in a subsequent transmission occasion in response to the transmitted performance metric.

In one embodiment, a method, performed by a base station (BS), for managing downlink reference signal transmission in a wireless system is disclosed. The method comprising transmitting, by the BS, a plurality of configuration parameters for a first reference signal transmitted using a plurality of active ports and a second reference signal transmitted on a subset of active ports, wherein the plurality of configuration parameters includes at least one of a performance metric, a criteria for performance monitoring, and configuration settings for the first reference signal and the second reference signal, transmitting, by the BS in a first transmission occasion, at least one of the first reference signal and the second reference signal, receiving, from the UE, a feedback message based on the criteria for the performance monitoring, selecting, for a subsequent transmission occasion, one of the first reference signal, the second reference signal, or no reference signal, based on the received feedback message, and transmitting, by the BS in the subsequent transmission occasion, the selected one of the first reference signal, the second reference signal, or no reference signal.

In one aspect, wherein the configuration settings include at least one of scheduling and CSI acquisition using a CSI-RS.

In one aspect, wherein the scheduling and CSI acquisition are based on one of a request or a report.

In one aspect, wherein the scheduling is one of a downlink dynamic scheduling, downlink semi-persistent scheduling, and downlink multi-slot scheduling.

In one aspect, wherein for the downlink dynamic scheduling, the subsequent transmission occasion is dynamically scheduled based on the received feedback message.

In one aspect, wherein the request-based downlink SPS comprises transmitting, by the base station, an SPS scheduling grant comprising a first pattern of the first reference signal and the second reference signal, transmitting, by the base station, an SPS activation signal, transmitting, by the base station, a plurality of data channels in the first transmission occasion, receiving, by the base station, the request for a scheduling grant comprising a second pattern based on the performance metric criterion, selecting the second pattern of the first reference signal and the second reference signal based on the received request, and transmitting, for a subsequent SPS transmission, a scheduling grant comprising the selected pattern.

In one aspect, wherein the report-based downlink SPS comprises transmitting, by the base station, an SPS scheduling grant comprising a first pattern of the first reference signal and the second reference signal, transmitting, by the base station, an SPS activation signal, transmitting, by the base station, a plurality of data channels in the first transmission occasion, receiving, by the base station, a report of the performance metric, selecting a second pattern of the first reference signal and the second reference signal based on the reported performance metric, and transmitting, for a subsequent SPS transmission, a scheduling grant comprising the selected pattern.

In one aspect, wherein the request-based downlink MS scheduling comprises transmitting, by the base station, an MS grant comprising a first pattern of the first reference signal and the second reference signal for a first MS transmission occasion, transmitting, by the base station, an MS activation signal, transmitting, by the base station, a plurality of data channels in the first MS transmission occasion, receiving, by the base station, a request for an MS grant comprising a second pattern based on the performance metric criterion, selecting the second pattern of the first reference signal and the second reference signal based on the received request, and transmitting, for a subsequent MS transmission occasion, an MS grant comprising the selected pattern.

In one aspect, wherein the report-based downlink MS scheduling comprises transmitting, by the base station, an MS grant comprising a first pattern of the first reference signal and the second reference signal for a first MS transmission occasion, transmitting, by the base station, an MS activation signal, transmitting, by the base station, a plurality of data channels in the first MS transmission occasion, receiving, by the base station, a report of the performance metric, selecting a second pattern of the first reference signal and the second reference signal based on the reported performance metric, and transmitting, for a subsequent MS transmission occasion, an MS grant comprising the selected pattern.

In one aspect, wherein the request-based CSI acquisition comprises transmitting, by the base station in a first CSI acquisition occasion, at least one of the first reference signal and the second reference signal to enable CSI determination, receiving, from the UE, a feedback message comprising a CSI report and a request for a subsequent CSI reference signal transmission, selecting, for a subsequent CSI acquisition occasion, one of the first reference signal, the second reference signal, or no reference signal based on the received request, and transmitting, by the base station in the subsequent CSI acquisition occasion, the selected one of the first reference signal, the second reference signal, or no reference signal.

In one aspect, wherein the report-based CSI acquisition comprises transmitting, by the base station in a first CSI acquisition occasion, at least one of the first reference signal and the second reference signal to enable CSI determination, receiving, from the UE, a feedback message comprising a CSI report and a reported performance metric, selecting, for a subsequent CSI acquisition occasion, one of the first reference signal, the second reference signal, or no reference signal based on the reported performance metric, and transmitting, by the base station in the subsequent CSI acquisition occasion, the selected one of the first reference signal, the second reference signal, or no reference signal.

In one embodiment, a method of uplink reference signal transmission in a wireless communication system is disclosed. The method comprising receiving, by the UE, a plurality of configuration parameters for transmitting a first reference signal using a plurality of active ports and transmitting a second reference signal on a subset of the plurality of active ports, transmitting, by the UE, a first uplink transmission comprising at least one of the first reference signal and the second reference signal in a first transmission occasion, receiving, by the UE, an indication from a base station for transmitting at least one of the first reference signal and the second reference signal for a subsequent transmission occasion, and transmitting, by the UE, a subsequent uplink transmission comprising at least one of the first reference signal and the second reference signal in the subsequent transmission occasion based on the indication.

In one aspect, wherein the configuration parameters include settings for at least one of an uplink dynamic scheduling, an uplink configured grant (CG), and a CSI acquisition using a sounding reference signal (SRS).

In one aspect, wherein for the uplink dynamic scheduling, the method comprises transmitting, by the UE, a scheduling request for the first uplink transmission occasion, receiving, by the UE, a first uplink grant indicating one of the first reference signal and the second reference signal for the first transmission occasion, transmitting the first uplink transmission using one of the indicated first reference signal and second reference signal, transmitting, by the UE, a scheduling request for the subsequent transmission occasion, receiving, by the UE, a second uplink grant indicating one of the first reference signal and the second reference signal for the subsequent transmission occasion, and transmitting the second uplink transmission using one of the indicated first reference signal and second reference signal.

In one aspect, wherein for uplink CG, the method comprises receiving, by the UE, a CG configuration comprising a default first pattern for the reference signal transmission, receiving, by the UE, for a Type 2 CG, an activation signal, wherein the activation signal comprises an optional indication of a second pattern for the reference signal transmission, determining, by the UE, the pattern for a given CG transmission occasion to be the second pattern, if the second pattern is indicated in the activation signal, or the default first pattern, if the second pattern is not indicated, and transmitting, by the UE, the uplink transmission comprising the reference signal corresponding to the pattern on a configured resource.

In one aspect, wherein the second pattern is a pattern indicated by the base station based on a performance metric of a prior uplink transmission.

In one aspect, wherein the CSI acquisition using SRS comprises receiving, by the UE, an SRS configuration comprising a default reference signal for an initial transmission, wherein the configuration defines parameters for the first reference signal and the second reference signal, transmitting, by the UE, the default reference signal for CSI acquisition in the first transmission occasion, receiving, by the UE, an indication for one of the first reference signal and the second reference signal for a subsequent transmission occasion, and transmitting, by the UE, one of the indicated first reference signal and second reference signal for CSI acquisition in the subsequent transmission occasion.

In one embodiment, a method of uplink reference signal reception at a base station (BS) in a wireless communication system is disclosed. The method comprising transmitting, by the BS, a plurality of configuration parameters for transmitting a first reference signal using a plurality of active ports and transmitting a second reference signal on a subset of the plurality of active ports, receiving, by the BS, a first uplink transmission comprising at least one of the first reference signal and the second reference signal in a first transmission occasion, evaluating, by the BS, a performance on the first uplink transmission, determining one or more of the first reference signal and the second reference signal based on the evaluation, and transmitting, by the BS, an indication of one or more of the first reference signal and the second reference signal for a subsequent transmission occasion.

In one aspect, wherein the configuration parameters include settings for at least one of an uplink dynamic scheduling, an uplink configured grant (CG), and a CSI acquisition using a sounding reference signal (SRS).

In one aspect, wherein for the uplink dynamic scheduling, the method comprises receiving, by the BS, a scheduling request for the first uplink transmission occasion, transmitting, by the BS, a first uplink grant indicating one of the first reference signal and the second reference signal for the first transmission occasion, receiving the first uplink transmission using one of the indicated first reference signal and the second reference signal, receiving, by the BS, a scheduling request for the subsequent transmission occasion, and transmitting, by the BS, a second uplink grant indicating one of the first reference signal and the second reference signal for the subsequent transmission occasion.

In one aspect, wherein for uplink CG, the method comprises transmitting, by the BS, a CG configuration comprising a default first pattern for the reference signal transmission, and transmitting, by the BS, for a Type 2 CG, an activation signal, wherein the activation signal comprises an optional indication of a second pattern for the reference signal transmission.

In one aspect, wherein the second pattern is a pattern indicated by the base station based on a performance metric of a prior uplink transmission.

In one aspect, wherein the CSI acquisition using SRS comprises transmitting, by the BS, an SRS configuration comprising a default reference signal for an initial transmission, wherein the configuration defines parameters for the first reference signal and the second reference signal, receiving, by the BS, the default reference signal for CSI acquisition in the first transmission occasion, and receiving, by the BS, in the subsequent transmission occasion, the one of the first reference signal and the second reference signal transmitted by the UE in response to the indication.

Other aspects and advantages of the present disclosure will become apparent from the following description, taken in conjunction with the accompanying drawings, illustrating by way of example the principles of the invention.

### BRIEF DESCRIPTION OF THE DRAWINGS

The accompanying drawings constitute a part of the description and are used to provide further understanding of the present disclosure. Such accompanying drawings illustrate the embodiments of the present disclosure which are used to describe the principles of the present disclosure. The embodiments are illustrated by way of example and not by way of limitation in the figures of the accompanying drawings in which references indicate similar elements. It should be noted that references to “an” or “one” embodiment in this invention are not necessarily to the same embodiment, and they mean at least one. In the drawings:

FIG. 1 illustrates a schematic overview of the wireless communication network, in accordance with embodiments of the present disclosure;

FIG. 2 illustrates an exemplary example of a sequence diagram for on-demand reference signal (Downlink), in accordance with an embodiment of the present disclosure;

FIG. 3 illustrates an exemplary example of a sequence diagram for on-demand reference signal (Uplink), in accordance with an embodiment of the present disclosure;

FIG. 4 illustrates an exemplary example of a sequence diagram for on-demand RS (RS1) and low-density RS (RS2), in accordance with an embodiment of the present disclosure;

FIG. 5 illustrates an exemplary example of a sequence diagram for downlink dynamic scheduling of data channel with request-based on-demand RS, in accordance with an embodiment of the present disclosure;

FIG. 6 illustrates an exemplary example of a sequence diagram for downlink dynamic scheduling of data channel with report-based on-demand RS, in accordance with an embodiment of the present disclosure;

FIG. 7 illustrates an exemplary example of a sequence diagram for downlink semi-persistent scheduling of data channel with request-based on-demand RS, in accordance with an embodiment of the present disclosure;

FIG. 8 illustrates an exemplary example of a sequence diagram for downlink semi-persistent scheduling of data channel with report-based on-demand RS, in accordance with an embodiment of the present disclosure;

FIG. 9 illustrates an exemplary example of a sequence diagram for downlink multi-slot scheduling of data channel with request-based on-demand RS, in accordance with an embodiment of the present disclosure;

FIG. 10 illustrates an exemplary example of a sequence diagram for downlink multi-slot scheduling of data channel with report-based on-demand RS, in accordance with an embodiment of the present disclosure;

FIG. 11 illustrates an exemplary example of a sequence diagram for uplink dynamic of data channel, in accordance with an embodiment of the present disclosure;

FIG. 12 illustrates an exemplary example of a sequence diagram for uplink configured-grant scheduling of data channel, in accordance with an embodiment of the present disclosure;

FIG. 13 illustrates an exemplary example of a sequence diagram for CSI acquisition using CSI-RS based on request, in accordance with an embodiment of the present disclosure;

FIG. 14 illustrates an exemplary example of a sequence diagram for CSI acquisition using CSI-RS based on report, in accordance with an embodiment of the present disclosure;

FIG. 15 illustrates an exemplary example of a sequence diagram for CSI acquisition using SRS, in accordance with an embodiment of the present disclosure;

FIG. 16 illustrates a method flow diagram for managing downlink reference signal transmission in a wireless system performed by the UE, in accordance with an embodiment of the present disclosure;

FIG. 17 illustrates a method flow diagram for managing downlink reference signal transmission in a wireless system performed by a base station, in accordance with an embodiment of the present disclosure;

FIG. 18 illustrates a method flow diagram of uplink reference signal transmission in a wireless communication system, in accordance with an embodiment of the present disclosure;

FIG. 19 illustrates a method flow diagram of uplink reference signal reception in a wireless communication system, in accordance with an embodiment of the present disclosure;

FIG. 20 illustrates a schematic diagram illustrating an example of the user equipment (UE) in a wireless communication network, in accordance with embodiments of the present disclosure;

FIG. 21 illustrates a schematic diagram illustrating an example of the base station in a wireless communication network, in accordance with embodiments of the present disclosure.

### DETAILED DESCRIPTION OF THE INVENTION

The detailed description set forth below in connection with the appended drawings is intended as a description of various embodiments of the present disclosure and is not intended to represent the only embodiments in which the present disclosure may be practiced. Each embodiment described in this invention is provided merely as an example or illustration of the present disclosure, and should not necessarily be construed as preferred or advantageous over other embodiments. The detailed description includes specific details for the purpose of providing a thorough understanding of the present disclosure. However, it will be apparent to those skilled in the art that the present disclosure may be practiced without these specific details.

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “in another embodiment”, “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment). The expression “at least one of A, B and C” or “at least one of the following: A, B and C” means “only A, or only B, or only C, or any combination of A, B and C.”

The word “example” or “exemplary” is used herein to mean “serving as an example, instance, or illustration.” Any implementation described herein as “exemplary” is not necessarily to be construed as preferred or advantageous over other implementations

The following disclosure is intended to particularly describe the implementations of various aspects of the embodiment. The new radio (NR) specification defines different reference signal (RS) for different purpose like demodulation reference signal (DMRS) for providing channel estimates to enable demodulation of data and channel state information reference signal (CSI-RS) and sounding reference signal (SRS) for channel state information (CSI) estimation. The process of ‘channel estimation’ involves initial estimation, along with interpolation and extrapolation of the estimates as and when required.

Ports for a RS refer to logical entities that node 1 and node 2 use to identify and process the RS. In the downlink, node 1 is the network and node 2 is the user equipment (UE), while in the uplink node 1 is the UE and node 2 is the network. Each port corresponds to a specific channel or spatial layer through which the RS is transmitted. These ports indicate distinct paths for signal transmission. As per the 5G NR definition, “an antenna port is defined such that the channel over which a symbol on the antenna port is conveyed may be inferred from the channel over which another symbol on the same antenna port is conveyed”.

A signal transmitted through a particular port may have certain large-scale channel properties in common with a signal transmitted through another port. In such cases, the two ports are said to be quasi-colocated (QCL). For example, a DM-RS may inherit the delay spread calculated from a QCL'ed CSI-RS. The parameters that are inherited in such a fashion are determined at least by the type of QCL relation as defined in the NR specifications. These QCL relations are configured in the UE by the network a.k.a. next-generation node-B (gNB) using transmission configuration indicator (TCI) states. It should be noted that the usage of the term gNB is for the ease in mapping its functionality to existing 5G systems. Its usage should not be constructed as limiting this invention in any way to the 5G framework.

The RSs in 5G NR are often configured to repeat the transmission in a periodic fashion. However, the recent trends in standardization are moving towards reduction of any periodic phenomenon to improve resource utilization efficiency. The new paradigm leans towards event-driven procedures necessitates a re-evaluation of the existing periodic RSs defined for 5G. Specifically, there is a need to make the RSs ‘on-demand’—i.e., the RSs will be transmitted only when the UE requests to transmit them and/or when the gNB decides to transmit them. When transmitted on a physical channel, it may choose to transmit the same RS with same resource utilization or completely skip the RS transmission or transmit another RS with a lower resource utilization in some transmission occasions. The resources freed up in the latter two cases may be used for transmitting additional data or to add redundancy for error control coding or control signaling through the physical channels. of the wireless channel due to mobility of the transmitter or receiver or the environment.

Such a system naturally requires a way to identify the need to transmit the full-density RS either at the UE or at the gNB. This in turn requires careful monitoring of one or more performance metrics (or simply, ‘metrics’ in the context of this PS) of the system even while improving the channel estimation using the channel estimates of the past instances. The monitoring will require a new RS, but this RS may be designed to be efficient resource utilization with lower density required to enable the above functionality.

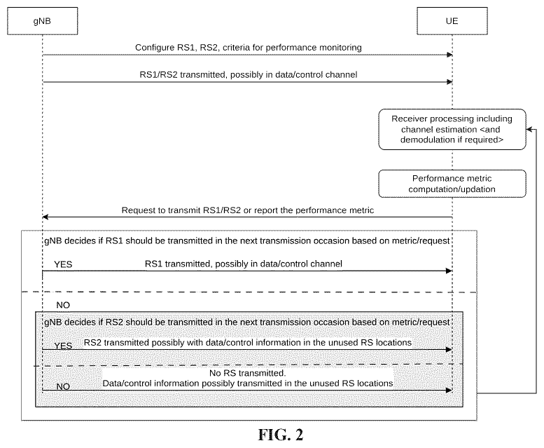

The proposed implementation of an on-demand RS for downlink is illustrated in FIG. 2. The essential components of the system are as follows. RS1 represents the primary RS, with a higher reference signal density, while RS2 serves as the secondary RS, with a lower reference signal density. Density is determined by the number of ports, resource elements (REs) per resource block (RB), or both. In a typical setup, the high-density RS1 may be transmitted on demand, while RS2 or no RS is transmitted when RS1 density is not needed. In other configurations, RS2 or no RS may also be on-demand. The choice of on-demand RS depends on factors like the use case, mobility expectations, and reliability requirements. Most of the figures in this document show RS1 as the on-demand RS, but this is for illustration only and is not a limitation. Additionally, a lack of explicit request for an on-demand RS may be interpreted as an implicit request for the alternative RS. For example, if RS1 is the on-demand RS and is not requested for a transmission, this may imply a request for RS2 or no RS. The network determines which to use based on scheduling and prior requests or reports.

The UE either requests the on-demand RS when needed based on a performance metric that it calculates or reports a metric that it calculated to the gNB. The gNB then considers the UE's request or report and transmits the appropriate RS. This system allows for adjusting pilot density based on the speed of channel variation. Transmitting RS2 results in a lower pilot density, while transmitting no RS eliminates pilot overhead. This frees up more resource elements (REs) in a slot or frame, allowing more data transmission in the transport block, added redundancy for error control, or the inclusion of new control signaling.

The RS used for channel estimation during demodulation is transmitted by the gNB over the physical downlink control channel (PDCCH) or physical downlink shared channel (PDSCH), or by the UE over the physical uplink shared channel (PUSCH) or physical uplink control channel (PUCCH), alongside data and/or control information. Similarly, the RS used for CSI acquisition is sent by the transmitter as CSI-RS in the downlink or SRS in the uplink.

RS2 is transmitted either on a subset of the same physical channel as RS1, on a different physical channel, or as an independent signal. At the receiver, RS2 may serve various purposes, including: Monitoring one or more performance metrics, as mentioned earlier track or adapt channel parameters, Update CSI parameters, Extrapolating/interpolating the wireless channel. It should be noted that RS1 may also be used for all the above purposes and results in higher accuracy for these tasks due to its increased RS density.

RS1 is transmitted using all active ports during one of the transmission occasions when data or control is sent over PDCCH, PDSCH, PUSCH, or PUCCH, or when CSI acquisition is needed. This ensures that the system has the necessary information to accurately estimate the channel. During other transmission occasions, the system either transmits RS2 on a subset of the ports or subset of resources, potentially at a lower density, or transmits no RS on all active ports. The substitution of RS1 with RS2 or no RS assumes the channel characteristics remain stable (due to factors such as low mobility, vehicle speed, Doppler effect, or time-selectivity), allowing the initial channel estimates to remain valid for a certain period. Thus, the system may rely on the initial estimates for later occasions, even without RS1. In this context, a “transmission occasion” refers to a specific time interval within the transmission schedule when node 1 either transmits an RS (RS1 or RS2) or refrains from transmitting any RS to node 2.

Although RS2 may use fewer ports than RS1, it is assumed that the time behavior of the subset of ports or resources reflects the behavior of the full set. Therefore, monitoring the subset of RS port from the group or the subset of resources is sufficient to assess performance. For example, RS2 is transmitted on one representative port per group during certain occasions to calculate a pre-configured performance metric. The relationship between the representative port and its parent subset is similar to the QCL relationships described earlier, indicating that the channel behavior of the subset at any given time is comparable to that of the representative port.

In one embodiment for downlink, where node 2 is a UE, if a preconfigured condition based on the performance metric is met, node 2 requests node 1 to transmit either RS1 or RS2 during the next transmission occasion. Alternatively, node 2 may report the performance metric to the network according to a predefined procedure, allowing the network to decide which RS (RS1, RS2, or none) will be transmitted in the next transmission occasion.

In another embodiment for uplink, where node 2 is a gNB, node 2 determines whether node 1 should transmit RS1,RS2, or no RS in the next transmission occasion based on the performance metric. These scenarios are discussed in detail in the following sections.

The described implementations may be executed in any device, system, or network that is capable of transmitting and receiving radio frequency (RF) signals according to any communication standard, such as Wi-Fi, LTE, LTE-Advanced, Fifth Generation (5G), Wideband Code Division Multiple Access (WCDMA), Global System for Mobile communications/Enhanced Data rate for GSM Evolution (GSM/EDGE), GSM/General Packet Radio Service (GPRS), Worldwide Interoperability for Microwave Access (WiMAX), or Ultra Mobile Broadband (UMB), Terrestrial Trunked Radio (TETRA), Advanced Mobile Phone System (AMPS), or other NTN-IoT, Narrowband-Internet of Things (NB-IoT) low power wide area (LPWA). The following embodiments pertain to technological advances that are especially relevant in the context of next-generation wireless systems such as 5G Advanced and Sixth Generation (6G), but they may also be used to enhance existing wireless communication systems such as LTE and 5G.

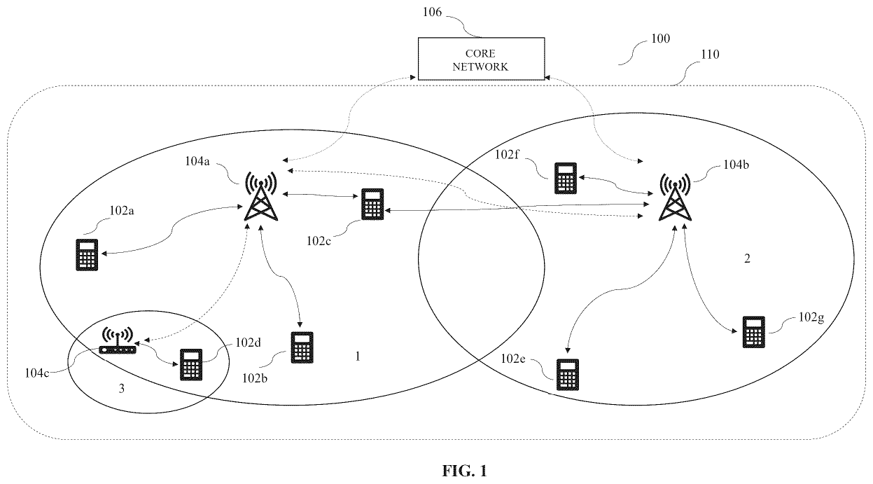

FIG. 1 is a schematic overview illustrating a wireless communication network 100 in accordance with an embodiment of the present disclosure. The wireless network may be a 4G long-term evolution (LTE) or a 5G New Radio (NR) or any other cellular network. The techniques described herein are implemented by one or more components of the wireless communication system. The wireless communication system 100 comprises a base station 104 and a UE 102, Core Network (CN) 106 and Access Network (AN) 110. The illustration shows a typical 5G system, however, it is understood that many variations may exist in 5G architecture.

In the wireless communication network (100) as illustrated in FIG. 1, wireless devices e.g. a UE 102 such as a mobile station, a non-access point (non-AP) STA, a STA, a user equipment (UE) and/or a wireless terminal, communicate via one or more Access Networks (AN), e.g. RANs, to one or more CNs. It is to be understood that “UE” is a non-limiting term which means any terminal, wireless communication device, user device, wireless communication terminal, user equipment, Machine Type Communication (MTC) device, Device to Device (D2D) terminal, or node e.g. smart phone, laptop, mobile phone, sensor, relay, mobile tablets or even a small base station capable of communicating using radio communication within the geographical coverage of the network.

The base stations 104 may be a transmission and reception point e.g. a radio network node such as a Wireless Local Area Network (WLAN) access point or an Access Point Station (AP STA), an access node, an access controller, a base station, e.g. a radio base station such as a NodeB, an evolved Node B (eNB, eNode B), a gNodeB (gNB), a base transceiver station, a radio remote unit, an Access Point Base Station, a base station router, a transmission arrangement of a radio base station, a stand-alone access point or any other network unit or node capable of communicating with a UE within the area served by the network nodes depending e.g. on the RAT and terminology used. The radio network nodes communicate with the UE in form of downlink (DL) transmissions to the one or more UEs and Uplink (UL) transmissions from the one or more UE.

In an embodiment, the wireless communication system 100 comprises a core network (CN) 106 that may provide authentication, authorization, internet protocol (IP) connectivity, routing, mobility, and other access.

FIG. 2 illustrates an exemplary example of a sequence diagram for on-demand reference signal (Downlink), in accordance with an embodiment of the present disclosure. FIG. 1 shows a sequence diagram illustrating an example implementation of a reduced reference signal density system in the downlink. Initially, the UE is configured with RS1 and RS2 using RRC signaling. The network transmits either RS1 or RS2 by default, possibly based on preconfiguration agreed upon between the network and the UE. If the RS is used for demodulation, it may be embedded in a physical channel along with data or control information. Alternatively, if the RS is used for channel sounding, it may be transmitted independently of any channel.

After receiving the RS, in addition to using it for channel estimation, the UE monitors performance using a performance metric. This metric allows the UE to either request RS1 or RS2, or it enables the gNB to decide whether RS1, RS2, or no RS will be transmitted in the next transmission occasion. By using RS2 or skipping RS transmission, the system may free up resources for data transmission or to add redundancy for error control coding. The UE may directly request RS1 or RS2 based on the calculated performance metric, or it may report the metric (or a derivative of it) to the gNB, which then decides whether to transmit RS1, RS2, or no RS. The performance monitoring unit tracks this metric to assist the system in optimizing RS transmission. For instance, it helps decide the type of RS, or whether to transmit any RS, in the next occasion.

Based on the performance monitoring unit's output, the UE either requests RS1 or RS2 from the gNB, or it reports the metric to enable the gNB to make this decision. The gNB then chooses whether to transmit RS1, RS2, or no RS, based on the UE's request or report. After the gNB transmits the new RS, the UE may use that along with one or more RS from previous occasions to estimate or update the channel.

Note that the gNB may schedule RS transmissions across multiple slots in a pattern of its choosing. The above diagram is not meant to convey that the gNB schedules an RS for each occasion independently. Instead, the gNB has the flexibility to schedule multiple consecutive RS transmissions, or multiple instances of no RS, based on the performance monitoring system's evaluations. The gNB decides whether to transmit or skip an RS on each occasion.

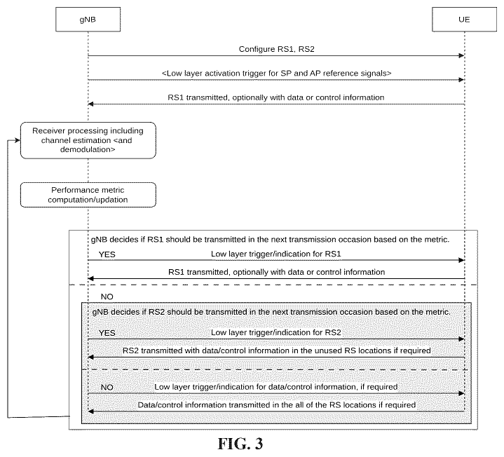

FIG. 3 illustrates an exemplary example of a sequence diagram for on-demand reference signal (Uplink), in accordance with an embodiment of the present disclosure. FIG. 3 showing an example implementation of a reduced reference signal density system in uplink. As earlier, the reference signals RS1 and RS2 needs to be configured in the UE with the help of RRC signaling. In case these uplink reference signals are configured as semi-persistent or aperiodic, a lower-layer activation trigger may be part of the initial signaling. The UE transmits either RS1 or RS2 by default, possibly as agreed upon during the preconfiguration. If the RS is used for demodulation, it may be embedded in a physical channel and transmitted alongside data or control information. Alternatively, an RS used for channel sounding may be transmitted independently of a channel.

The gNB receives the RS from the UE and performs channel estimation, optionally accompanied with demodulation if the RS forms part of a physical channel. In the uplink, the performance monitoring occurs in the gNB. Thus, the report or request from the UE does not exist. The UE simply sends the RS, and the performance monitoring and decision making are both carried out by the gNB.

The gNB may configure the UE to transmit the RS for multiple slots in a pattern of its choice. The above diagrams are not meant to convey that the gNB needs to schedule an RS for each occasion independently. Rather, it is free to schedule multiple occasions of an RS of its choice or multiple occasions of no RS depending on the interpretations of the performance monitoring system.

The performance monitoring unit situated either in the UE or the network monitors a performance metric which may be a derivative of the channel estimate quality, the outcome of the cyclic redundancy check (CRC) check or the number of hybrid automatic repeat request (HARQ) retransmissions, the quality of the LLR etc. against a relevant threshold configured by the gNB. This metric may also directly or indirectly indicate factors such as mobility/velocity of vehicle, Doppler or time-variation of the channel, which has a major impact on determining the requisite density of the RS.

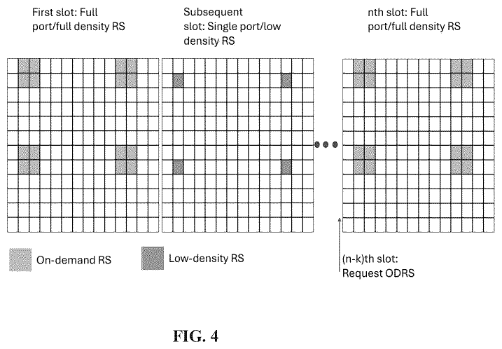

FIG. 4 illustrates an exemplary example of a sequence diagram for on-demand RS (RS1) and low-density RS (RS2), in accordance with an embodiment of the present disclosure. FIG. 4 shows an example of how the high density RS1 and the low-density RS2 may coexist in a system. The figure shows an example dynamic-grant based system where the RS1 is the on-demand RS. In each transmission occasion, it is assumed that a single slot is scheduled. RS1 is transmitted by default in slot 1. As RS1 is not requested for the subsequent transmission occasion, RS2 is scheduled by the gNB (assuming that the mobility is high enough to rule out the no RS scenario). RS2 continues to be scheduled, and the performance monitoring unit determines that RS1 is required to be transmitted at the end of slot n-k. The example allows for an application delay of k slots, and node 1 transmits RS1 again in the nth slot. Here, the slot n-k is dependent on the performance metric. Example implementations where the on-demand RS concept may be used are now shown.

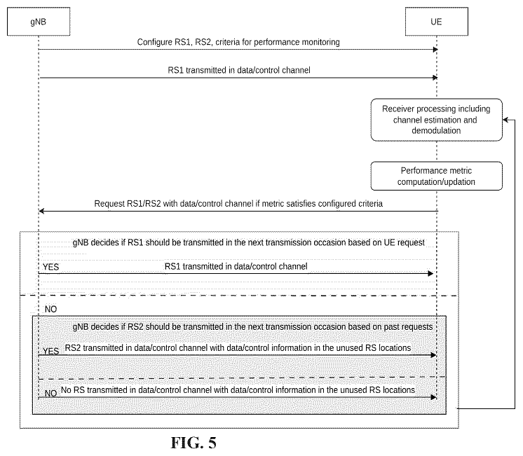

In an embodiment, the present disclosure discusses different adaptation of the reduced RS density schemes proposed in the previous section for different scenarios in downlink and uplink transmission. The different methods on how the reduced RS density scheme may be incorporated to the case of downlink dynamic scheduling based on a direct request from the UE for on-demand reference signal are illustrated as shown in FIG. 5.

FIG. 5 illustrates an exemplary example of a sequence diagram for downlink dynamic scheduling of data channel with request-based on-demand RS, in accordance with an embodiment of the present disclosure. After RRC configuration of the reference signals and the criteria for performance monitoring, RS1 is transmitted in the first transmission occasion. At the UE, the received RS1 is used for channel estimation, data demodulation and computing the performance metric. Depending on the value of the metric and the configured performance monitoring criteria, the UE requests one of either RS1 or RS2 for the next transmission occasion. The request is conveyed by the UE as a part of low-layer uplink control signaling. The gNB decides the RS to be transmitted in the downlink. If the decision is to transmit RS 2 or no RS, the unused RS locations may be used to transmit data or control information.

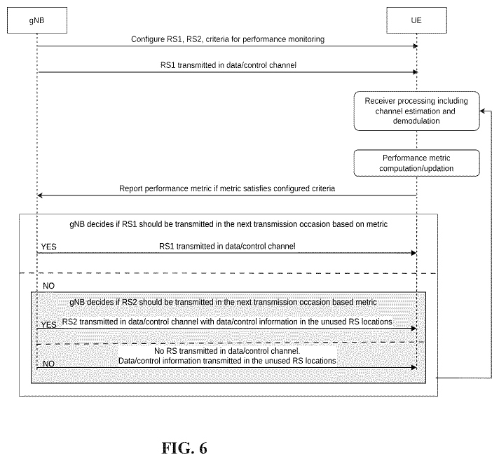

FIG. 6 illustrates an exemplary example of a sequence diagram for downlink dynamic scheduling of data channel with report-based on-demand RS, in accordance with an embodiment of the present disclosure. This method is similar to the request-based method, except that the UE does not request RS1/RS2 from the gNB. Instead, it transmits the performance metric or a function of the performance metric to the gNB through uplink control signaling. The gNB compares the reported metric with certain criteria. When the gNB schedules a downlink data transmission to the UE, it decides between RS1, RS2 and no RS based on the value of the performance metric and other scheduling considerations.

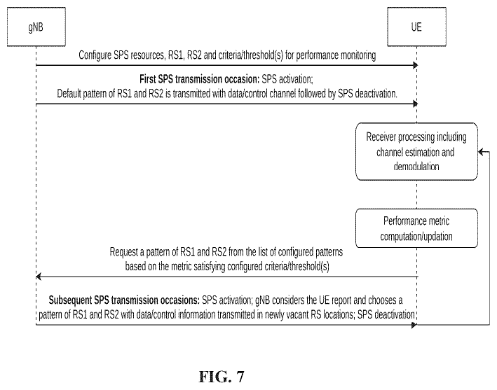

FIG. 7 illustrates an exemplary example of a sequence diagram for downlink semi-persistent scheduling of data channel with request-based on-demand RS, in accordance with an embodiment of the present disclosure. In semi-persistent scheduling (SPS), the gNB pre-configures PDSCH grant in the UE through RRC signaling. Whenever data is present in the downlink buffer for that UE, the gNB transmits an SPS activation signal to the UE. The first transmission occasion that follows this shall contain a default preconfigured pattern of RS1 and RS2 for the sequence of PDSCH transmissions.

The UE monitors the PDCCH and obtains the activation signal. The UE then expects SPS PDSCH to be received periodically until a deactivation signal for the same is received. A pre-defined PDSCH occasions or a pre-defined pattern of occasions or a periodic pattern of occasions are configured in RRC, where a pre-defined pattern of RS1 and RS2 is transmitted. In the occasions of PDSCH with RS1, the downlink channel is estimated using RS1 and data is demodulated. Similar to the previous cases, UE maintains a performance metric that measures the time variation of the channel and updates it using one or more of the reference signals. Based on this metric and a gNB configured condition, the UE may request the gNB to schedule one of the appropriate preconfigured patterns of RS1 and RS2 along with the upcoming PDSCH transmission. This indication may be sent using a uplink control information (UCI) signal (e.g., HARQ feedback for the previous PDSCH). If such request is not received, the gNB will transmit the predefined pattern over the upcoming SPS transmissions.

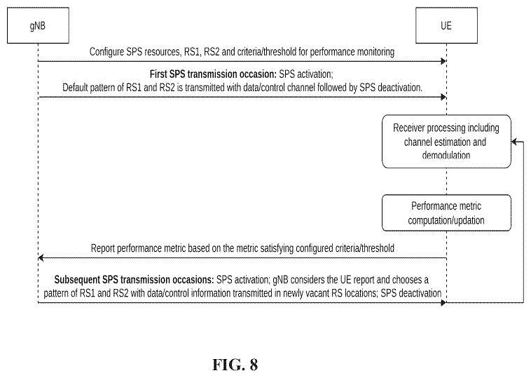

FIG. 8 illustrates an exemplary example of a sequence diagram for downlink semi-persistent scheduling of data channel with report-based on-demand RS, in accordance with an embodiment of the present disclosure. This method is similar to the request-based method, except that the UE does not request RS1/RS2 from the gNB. Instead, it transmits the performance metric or a function of the performance metric to the gNB through uplink control signaling. The gNB compares the reported metric with certain criteria. When the gNB schedules a downlink data transmission to the UE, it decides a pattern of RS1, RS2 and no RS for the slots in the transmission occasion based on the performance metric and other scheduling considerations.

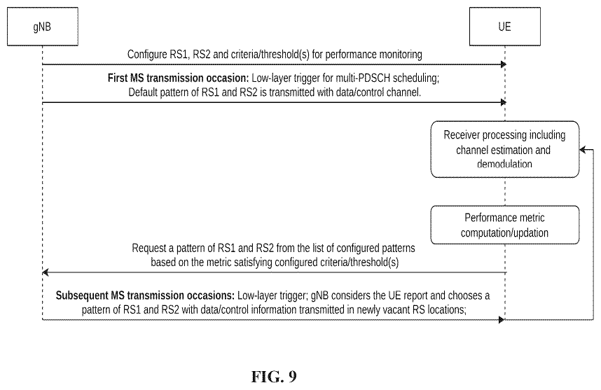

FIG. 9 illustrates an exemplary example of a sequence diagram for downlink multi-slot scheduling of data channel with request-based on-demand RS, in accordance with an embodiment of the present disclosure. In an embodiment, Multi-slot scheduling differs from SPS in that the PDCCH is not constantly monitored by the UE for multi-slot scheduling. The initial downlink control information (DCI) simply schedules multiple PDSCH occasions with a default pattern of RS1 and RS2. There is no deactivation signal for the multi-slot transmission as opposed to the SPS case. Similar to the previous cases, UE maintains a performance metric that measures the time variation of the channel and updates it using one or more of the reference signals. Based on this metric and a gNB configured condition, the UE may request the gNB to schedule a new pattern of RS1 and RS2 from a list of pre-configured available patterns for the next multi-slot transmission occasion. This indication may be sent using a UCI signal (e.g., HARQ feedback for the previous PDSCH or a separate signal). If a request for an RS pattern is not received, the gNB will transmit the next multi-slot occasion with the default pattern of RS1 and RS2.

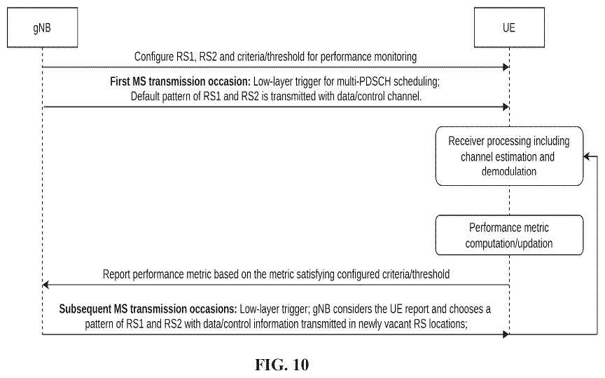

FIG. 10 illustrates an exemplary example of a sequence diagram for downlink multi-slot scheduling of data channel with report-based on-demand RS, in accordance with an embodiment of the present disclosure. This method is similar to the request-based method, except that the UE does not request RS1/RS2 from the gNB. Instead, it transmits the performance metric or a function of the performance metric to the gNB through uplink control signaling. The gNB compares the reported metric with certain criteria. When the gNB schedules a downlink data transmission to the UE, it decides a pattern of RS1, RS2 and no RS for the slots in the transmission occasion based on the performance metric and other scheduling considerations.

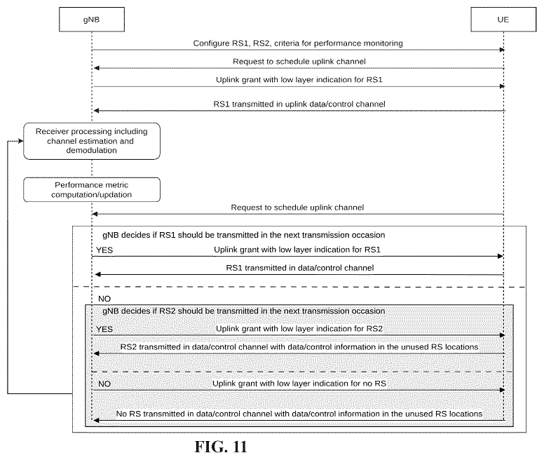

FIG. 11 illustrates an exemplary example of a sequence diagram for uplink dynamic of data channel, in accordance with an embodiment of the present disclosure. After RRC configuration of the RSs and the criteria for performance monitoring, the UE requests for an uplink channel through a scheduling request when data is present in the buffer for uplink transmission. In the first occasion, the gNB schedules the uplink data channel with RS1 based on resource availability. The scheduling decision is intimated via DCI to the UE. On transmission of PUSCH by the UE and reception by the gNB, the gNB performs PUSCH reception using RS1. In the subsequent transmission occasions, when data is present in the buffer the next time, the UE requests for an uplink data channel in SR. The gNB checks the performance metric to determine whether to schedule PUSCH with RS1 or RS2 or no RS and indicates the same to the UE.

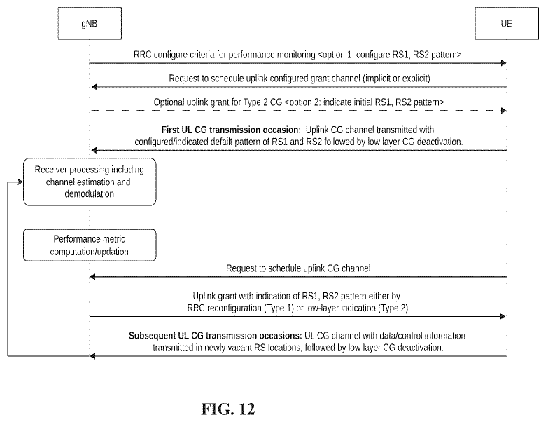

FIG. 12 illustrates an exemplary example of a sequence diagram for uplink configured-grant scheduling of data channel, in accordance with an embodiment of the present disclosure. When a continuous flow of data is expected for uplink transmission, the gNB configures/activates an uplink configured grant (CG) data channel through RRC/DCI. In the case of CG based scheduling of PUSCH, a pre-defined PUSCH occasions or a pre-defined pattern of occasions or a periodic pattern of occasions are configured in RRC, which also indicates the pattern of RS1 and RS2 in this transmission occasion. The uplink channel is estimated, and data is demodulated. Similar to the previous cases, the gNB maintains a performance metric that measures the time variation of the channel and updates it using one or more of the reference signals. Based on this metric, the gNB may decide to indicate the UE to transmit the upcoming PUSCH along with a selected pattern of RS1 and RS2 from the preconfigured list of patterns. If not, the UE will transmit the CG-PUSCH with the default RS1-RS2 pattern over the upcoming transmission occasion.

In an embodiment, CSI-RS is used in 5G for the purpose of calculating CSI such as channel quality information (CQI), precoding matrix indicator (PMI) and rank indicator (RI). This section details an adaptation of the proposed low density RS scheme as a method of CSI acquisition that reduces the need for frequent CSI-RS transmissions. Here, RS1 is the full density RS for CSI update and RS2 is the low-density RS that may be used for performance monitoring. Once again, the idea is to make one of the RS on-demand and effectively reduce the pilot overhead.

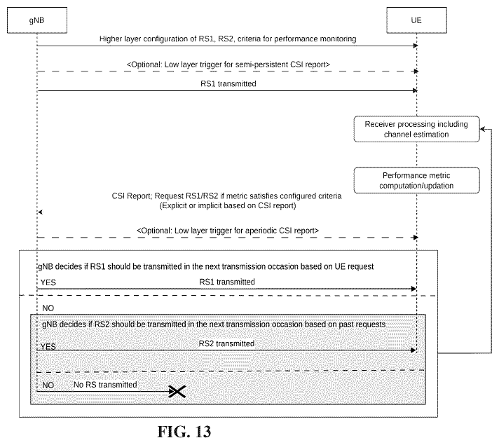

FIG. 13 illustrates an exemplary example of a sequence diagram for CSI acquisition using CSI-RS based on request, in accordance with an embodiment of the present disclosure. FIG. 13 shows the CSI acquisition process using CSI-RS as RS1. The procedure is equally applicable for periodic, semi persistent (SP) and aperiodic (AP) CSI-RS configurations. For semi-persistent CSI-RS, the start and stop triggers are configured with the UE. Whereas for aperiodic CSI-RS, only the corresponding trigger state is configured. Here, the UE calculates the performance metric and decides if RS1 or RS2 should be requested based on the performance metric satisfying some preconfigured criteria. The UE requests the on-demand RS from the gNB based on this criterion. The gNB considers the UE request while deciding between RS1 and RS2 and no RS in the subsequent transmissions. The request for on-demand RS may be explicit or implicit based on the CSI report.

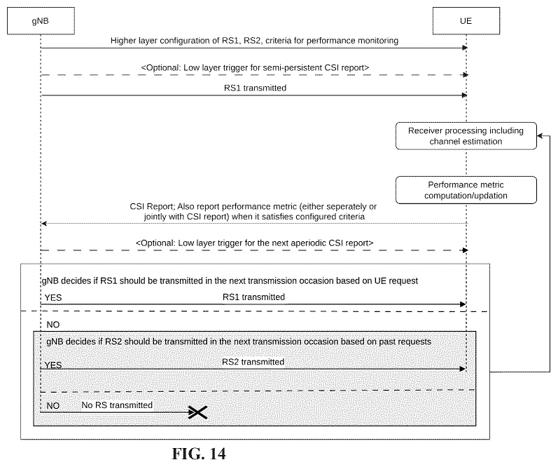

FIG. 14 illustrates an exemplary example of a sequence diagram for CSI acquisition using CSI-RS based on report, in accordance with an embodiment of the present disclosure. In the case of report-based CSI acquisition using CSI-RS, the UE initially receives RS1 (CSI-RS). It then calculates CSI parameters and transmits the report and the performance metric to the gNB. The UE report is used to guide the gNB decision on the subsequent transmission of RS1 or RS2 or no RS. In the case of report-based CSI acquisition using CSI-RS, the UE initially receives RS1 (CSI-RS). It then calculates CSI parameters and transmits the report and the performance metric to the gNB. The UE report is used to guide the gNB decision on the subsequent transmission of RS1 or RS2 or no RS.

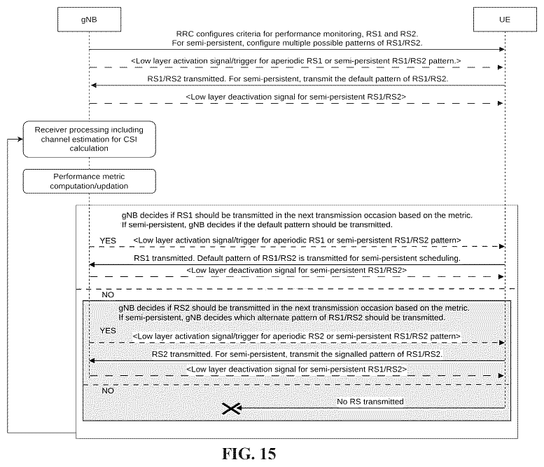

FIG. 15 illustrates an exemplary example of a sequence diagram for CSI acquisition using SRS, in accordance with an embodiment of the present disclosure. FIG. 15 shows the CSI acquisition process using SRS as RS1 and the low-density RS as RS2. Three distinct scheduling methods are described. In the aperiodic case, the gNB sends a specific signal to the UE to trigger the transmission of RS1 or RS2 as required, based on the performance metric. For the Semi-Persistent (SP) case, the gNB uses an activation signal to initiate a series of RS transmissions using a default pattern, and it may subsequently signal the UE to switch to a different pre-configured pattern if channel conditions change, ending each such sequence with a deactivation signal. In the Periodic case (where the dashed-line trigger signals are absent), the RS is transmitted at regular intervals based on the initial RRC configuration without the low-layer triggers for each transmission.

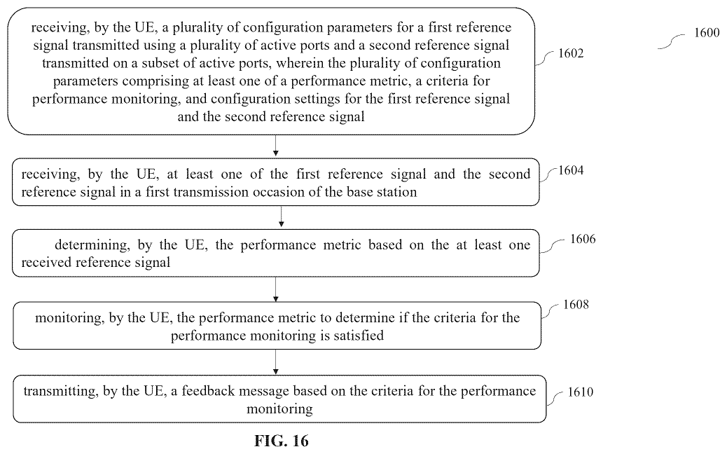

FIG. 16 illustrates a method flow diagram for managing downlink reference signal transmission in a wireless system performed by the UE, in accordance with an embodiment of the present disclosure. In an embodiment, the method 1600 comprising receiving, a plurality of configuration parameters for a first reference signal transmitted using a plurality of active ports and a second reference signal transmitted on a subset of active ports, wherein the plurality of configuration parameters comprising at least one of a performance metric, a criteria for performance monitoring, and configuration settings for the first reference signal and the second reference signal by a UE at 1602 and at least one of the first reference signal and the second reference signal in a first transmission occasion of the base station may be received by the UE at 1604. The performance metric based on the at least one received reference signal may be determined by the UE at 1606. The method further comprising monitoring, by the UE, the performance metric to determine if the criteria for the performance monitoring is satisfied at 1608, and transmitting, by the UE, a feedback message based on the criteria for the performance monitoring at 1610.

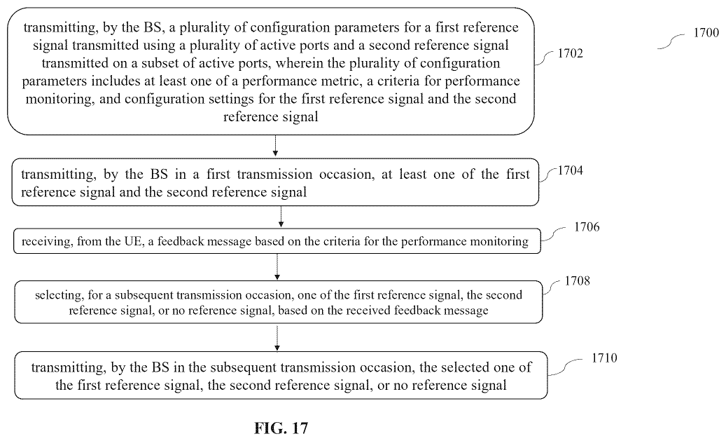

FIG. 17 illustrates a method flow diagram for managing downlink reference signal transmission in a wireless system performed by a base station, in accordance with an embodiment of the present disclosure. In one embodiment, the method 1700 comprising transmitting, by the BS, a plurality of configuration parameters for a first reference signal transmitted using a plurality of active ports and a second reference signal transmitted on a subset of active ports, wherein the plurality of configuration parameters includes at least one of a performance metric, a criteria for performance monitoring, and configuration settings for the first reference signal and the second reference signal at 1702, and transmitting, by the BS in a first transmission occasion, at least one of the first reference signal and the second reference signal at 1704. A feedback message may be received, from the UE, based on the criteria for the performance monitoring at 1706. The method further comprises of selecting, for a subsequent transmission occasion, one of the first reference signal, the second reference signal, or no reference signal, based on the received feedback message at 1708 and transmitting, by the BS in the subsequent transmission occasion, the selected one of the first reference signal, the second reference signal, or no reference signal at 1710.

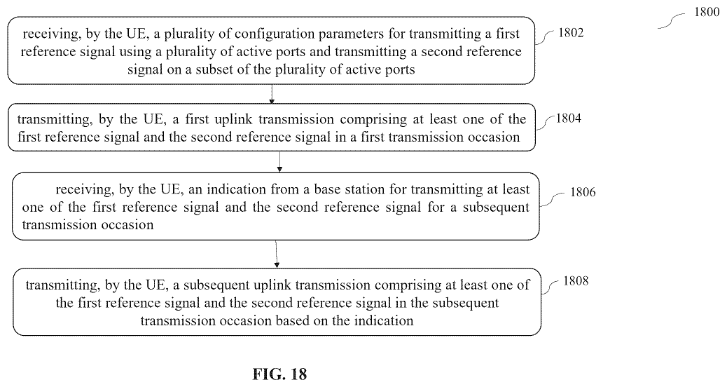

FIG. 18 illustrates a method flow diagram of uplink reference signal transmission in a wireless communication system, in accordance with an embodiment of the present disclosure. In one embodiment, the method 1800 comprising receiving, by the UE, a plurality of configuration parameters for transmitting a first reference signal using a plurality of active ports and transmitting a second reference signal on a subset of the plurality of active ports at 1802, and transmitting, by the UE, a first uplink transmission comprising at least one of the first reference signal and the second reference signal in a first transmission occasion at 1804. The method further comprises of receiving, by the UE, an indication from a base station for transmitting at least one of the first reference signal and the second reference signal for a subsequent transmission occasion at 1804 and transmitting, by the UE, a subsequent uplink transmission comprising at least one of the first reference signal and the second reference signal in the subsequent transmission occasion based on the indication at 1806.

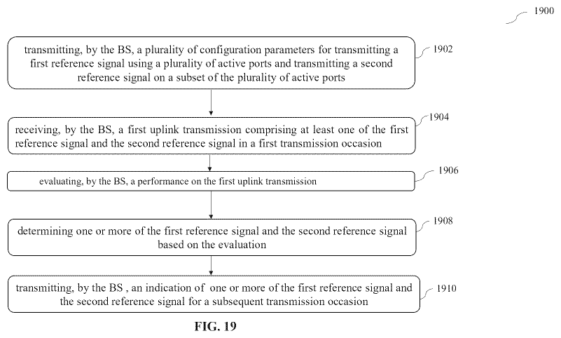

FIG. 19 illustrates a method flow diagram of uplink reference signal reception in a wireless communication system, in accordance with an embodiment of the present disclosure. In one embodiment, the method 1900 comprising transmitting, by the BS, a plurality of configuration parameters for transmitting a first reference signal using a plurality of active ports and transmitting a second reference signal on a subset of the plurality of active ports at 1902 and receiving, by the BS, a first uplink transmission comprising at least one of the first reference signal and the second reference signal in a first transmission occasion at 1904. The method further comprising evaluating, by the BS, a performance on the first uplink transmission at 1906, determining one or more of the first reference signal and the second reference signal based on the evaluation at 1908 and transmitting, by the BS, an indication of one or more of the first reference signal and the second reference signal for a subsequent transmission occasion at 1910.

The process as illustrated in FIG. 16 to FIG. 19 as logical flow diagram, each operation of which represents a sequence of operations that may be implemented in hardware, computer instructions, or a combination thereof. In the context of computer instructions, the operations represent computer-executable instructions stored on one or more computer-readable storage media that, when executed by one or more processors, perform the recited operations. The order in which the operations are described is not intended to be construed as a limitation, and any number of the described operations may be combined in any order and/or in parallel to implement the method.

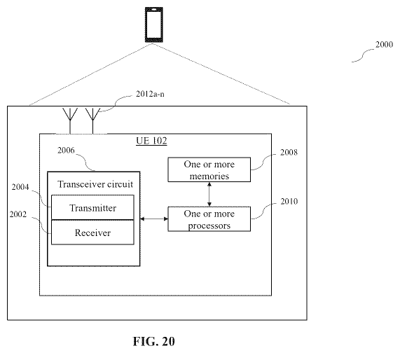

FIG. 20 illustrates a schematic diagram illustrating an example of the user equipment (UE) in a wireless communication network, in accordance with embodiments of the present disclosure. The apparatus may be an example of or include the components of the UE 102. The apparatus may comprise one or more processors 2010, one or more memories 2008, a transceiver 2006, and one or more antennas 2012a-n configured to perform the methods herein. The memory is in electronic communication with the one or more processor and instructions stored in the one or more memory and executable by the one or more processor. The transceiver of UE further includes a transmitter 2004 and a receiver 2002 to transmit and receive signal from the wireless communication device. The processor of the UE may be configured to perform the methods herein.

In one embodiment, the processor 2010 may be a single processing unit or a number of units, all of which could include multiple computing units. The processor 2010 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor 2010 is configured to fetch and execute computer-readable instructions and data stored in a memory 2008.

The memory 2008 may be any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The processor 2010 of the UE may be configured to perform the method steps as shown in FIGS. 16 and 18.

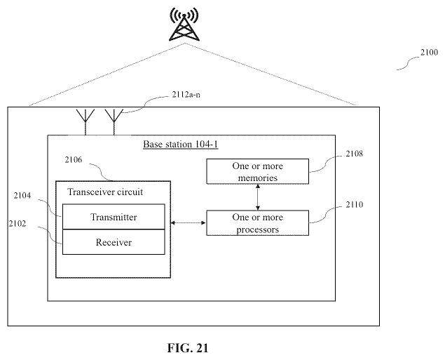

FIG. 21 illustrates a schematic diagram illustrating an example of the base station in a wireless communication network, in accordance with embodiments of the present disclosure. The apparatus may be an example of or include the components of a base station 104. The apparatus may comprise one or more processors 2110, one or more memories 2108, a transceiver circuit 2106, and one or more antennas 2112a-n configured to perform the methods herein. The memory is in electronic communication with the one or more processors and instructions stored in the one or more memories and executable by the one or more processors. The base station transceiver further includes a transmitter 2104 and a receiver 2102 to transmit and receive signal from the wireless communication device. The processor of the base station may be configured to perform the methods herein.

In one embodiment, the processor 2110 may be a single processing unit or a number of units, all of which could include multiple computing units. The processor 2110 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor 2110 is configured to fetch and execute computer-readable instructions and data stored in a memory 2108.

The memory 2108 may be any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The processor 2110 of the base station (gNB) may be configured to perform method step as shown in FIGS. 17 and 19.

In an embodiment of this disclosure, an antenna and a radio frequency circuit that have a receiving and sending function may be considered as a transceiver unit of the terminal. The transceiver unit may also be referred to as a transceiver (including a transmitter and/or a receiver), a transceiver machine, a transceiver apparatus, or the like. The processing unit may also be referred to as a processor, a processing module, a processing apparatus, or the like. Optionally, a component configured to implement a receiving function in the transceiver unit may be considered as a receiving unit, and a component configured to implement a sending function in the transceiver unit may be considered as a transmitting unit. In other words, the transceiver unit includes the receiving unit and the transmitting unit. This is not to be accorded as a limitation of the embodiment described in this disclosure.

In some embodiments, the transceiver unit and the processing unit may be integrated together or may be disposed independently. In addition, all functions of the processing unit may be integrated into one chip for implementation. Alternatively, some functions may be integrated into one chip for implementation and some other functions are integrated into one or more other chips for implementation.

The figures of the disclosure are provided to illustrate some examples of the invention described. The figures are not to limit the scope of the depicted embodiments or the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments may be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a script language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub combination. Moreover, although features may be described above as acting in certain combinations and even initially claimed as such, one or more features from a claimed combination may in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

1. A method, performed by a user equipment (UE), for managing downlink reference signal transmission in a wireless system, the method comprising:
receiving, by the UE, a plurality of configuration parameters for a first reference signal transmitted using a plurality of active ports and a second reference signal transmitted on a subset of active ports, wherein the plurality of configuration parameters comprising at least one of a performance metric, a criteria for performance monitoring, and configuration settings for the first reference signal and the second reference signal;
receiving, by the UE, at least one of the first reference signal and the second reference signal in a first transmission occasion of the base station;
determining, by the UE, the performance metric based on the at least one received reference signal;
monitoring, by the UE, the performance metric to determine if the criteria for the performance monitoring is satisfied; and
transmitting, by the UE, a feedback message based on the criteria for the performance monitoring.

2. The method as claimed in claim 1, wherein the performance metric is determined periodically or based on one or more transmission occasions.

3. The method as claimed in claim 2, further comprising:
transmitting, by the UE, the performance metric or a function of the performance metric.

4. The method as claimed in claim 3, further comprising:
receiving, by the UE, at least one of the first reference signal, the second reference signal, or not receiving any reference signal in the subsequent transmission occasion, wherein the first reference signal, the second reference signal, or not receiving any reference signal are received based on one of the reported performance metric or a request in the feedback message;
and performing, using the received reference signal, at least one of channel estimation, data demodulation, control information processing, and computing the performance metric.

5. The method as claimed in claim 1, wherein the configuration settings include at least one of a scheduling and CSI acquisition using a CSI-RS.

6. The method as claimed in claim 5, wherein the scheduling and CSI acquisition are based on one of a request or a report.

7. The method as claimed in claim 5, wherein the scheduling is one of a downlink dynamic scheduling, downlink semi-persistent scheduling, and downlink multi-slot scheduling.

8. The method as claimed in claim 1, further comprising:
determining, based on configuration settings, whether the first reference signal and the second reference signal are scheduled as one of semi-persistent and multi-slot;
triggering lower-layer activation for initial signaling; and
receiving a configured pattern of the first reference signal and the second reference signal along with the downlink reception.

9. The method as claimed in claim 1, wherein monitoring the performance at the UE comprises:
monitoring the performance metric indicative of a time-variation of the channel, such as a channel quality estimate, an outcome of the CRC check, a number of HARQ retransmissions, or a quality of the LLR.

10. The method as claimed in claim 1, wherein a request or report contained in a feedback message is transmitted using a low-layer uplink channel.

11. The method as claimed in claim 7, wherein the request-based downlink semi-persistent scheduling (SPS) comprises:
receiving, by the UE, a scheduling grant comprising a first pattern of the first reference signal and the second reference signal;
receiving, by the UE, an SPS activation signal;
receiving, by the UE, plurality of data channels with a configured SPS periodicity in the first transmission occasion;
determining, by the UE, the association between the plurality of data channels and at least one of the first reference signal and the second reference signal based on the pattern;
performing at least one of channel estimation, data demodulation, and computing the performance metric; and
transmitting, by the UE, a request for a scheduling grant comprising a second pattern of the first reference signal and the second reference signal based on the performance metric criterion.

12. The method as claimed in claim 11, wherein the request is implicitly conveyed using feedback like Hybrid Automatic Repeat Request (HARQ) feedback.

13. The method as claimed in claim 11, the method further comprising:
receiving, by the UE, an SPS activation signal; and
receiving the second pattern of the first reference signal and the second reference signal;

14. The method as claimed in claim 7, wherein the report-based downlink semi-persistent scheduling (SPS) comprises:
receiving, by the UE, a scheduling grant comprising a first pattern of the first reference signal and the second reference signal;
receiving, by the UE, an SPS activation signal;
receiving, by the UE, plurality of data channels with a configured SPS periodicity in the first transmission occasion;
determining, by the UE, the association between the plurality of data channels and at least one of the first reference signal and the second reference signal based on the pattern;
performing at least one of channel estimation, data demodulation, and computing the performance metric; and
reporting, by the UE, the performance metric.

15. The method as claimed in claim 14, the method further comprising, receiving, by the UE, an SPS activation signal; and
receiving the second pattern of the first reference signal and the second reference signal.

16. The method as claimed in claim 7, wherein the request-based downlink multi-slot (MS) scheduling comprises:
receiving, by the UE, an MS scheduling grant comprising a first pattern of the first reference signal and the second reference signal;
receiving, by the UE, an MS activation signal;
receiving, by the UE, a plurality of data channels in a first MS transmission occasion;
determining, by the UE, an association between the plurality of data channels and at least one of the first reference signal and the second reference signal based on the pattern;
performing at least one of channel estimation, data demodulation, and computing the performance metric; and
transmitting, by the UE, a request for an MS grant comprising a second pattern of the first reference signal and the second reference signal based on the performance metric criterion.

17. The method as claimed in claim 16, wherein the request is transmitted using low-layer uplink feedback.

18. The method as claimed in claim 16, further comprising:
receiving, by the UE, an MS activation signal for a subsequent MS transmission; and
receiving the second pattern of the first reference signal and the second reference signal.

19. The method as claimed in claim 7, wherein the report-based downlink MS scheduling comprises:
receiving, by the UE, an MS scheduling grant comprising a first pattern of the first reference signal and the second reference signal;
receiving, by the UE, an MS activation signal;
receiving, by the UE, a plurality of data channels in a first MS transmission occasion;
determining, by the UE, an association between the plurality of data channels and at least one of the first reference signal and the second reference signal based on the pattern;
performing at least one of channel estimation, data demodulation, and computing the performance metric; and
reporting, by the UE, the performance metric.

20. The method as claimed in claim 19, further comprising:
receiving, by the UE, an MS activation signal for a subsequent transmission; and
receiving the second pattern of the first reference signal and the second reference signal.

21. The method as claimed in claim 6, wherein the request-based CSI acquisition comprises:
receiving, by the UE, one of the first reference signal and the second reference signal;
generating, by the UE, a CSI report based on CSI parameters;
determining, by the UE, a performance metric based on one of the first reference signal and the second reference signal;
requesting one of the first reference signal and the second reference signal for a subsequent reference signal reception, wherein the request is based on the performance metric; and
transmitting, by the UE, the CSI report and the request.

22. The method as claimed in claim 21, further comprising:
receiving one of the first reference signal, the second reference signal, or no reference signal in a subsequent reception occasion in response to the transmitted request.

23. The method as claimed in claim 21, wherein the request is transmitted explicitly or implicitly based on the CSI report.

24. The method as claimed in claim 6, wherein the report-based CSI acquisition comprises:
receiving, by the UE, one of the first reference signal and the second reference signal;
generating, by the UE, a CSI report based on CSI parameters;
determining, by the UE, a performance metric based on one of the first reference signal and the second reference signal; and
transmitting, by the UE, the CSI report and the performance metric.

25. The method as claimed in claim 24, further comprising:
receiving, by the UE, one of the first reference signal, the second reference signal, or no reference signal, in a subsequent transmission occasion in response to the transmitted performance metric.

26. A method, performed by a base station (BS), for managing downlink reference signal transmission in a wireless system, the method comprising:
transmitting, by the BS, a plurality of configuration parameters for a first reference signal transmitted using a plurality of active ports and a second reference signal transmitted on a subset of active ports, wherein the plurality of configuration parameters includes at least one of a performance metric, a criteria for performance monitoring, and configuration settings for the first reference signal and the second reference signal;
transmitting, by the BS in a first transmission occasion, at least one of the first reference signal and the second reference signal;
receiving, from the UE, a feedback message based on the criteria for the performance monitoring;
selecting, for a subsequent transmission occasion, one of the first reference signal, the second reference signal, or no reference signal, based on the received feedback message; and
transmitting, by the BS in the subsequent transmission occasion, the selected one of the first reference signal, the second reference signal, or no reference signal.

27. The method as claimed in claim 26, wherein the configuration settings include at least one of scheduling and CSI acquisition using a CSI-RS.

28. The method as claimed in claim 27, wherein the scheduling and CSI acquisition are based on one of a request or a report.

29. The method as claimed in claim 27, wherein the scheduling is one of a downlink dynamic scheduling, downlink semi-persistent scheduling, and downlink multi-slot scheduling.

30. The method as claimed in claim 29, wherein for the downlink dynamic scheduling, the subsequent transmission occasion is dynamically scheduled based on the received feedback message.

31. The method as claimed in claim 29, wherein the request-based downlink SPS comprises:
transmitting, by the base station, an SPS scheduling grant comprising a first pattern of the first reference signal and the second reference signal;
transmitting, by the base station, an SPS activation signal;
transmitting, by the base station, a plurality of data channels in the first transmission occasion;
receiving, by the base station, the request for a scheduling grant comprising a second pattern based on the performance metric criterion;
selecting the second pattern of the first reference signal and the second reference signal based on the received request; and
transmitting, for a subsequent SPS transmission, a scheduling grant comprising the selected pattern.

32. The method as claimed in claim 29, wherein the report-based downlink SPS comprises:
transmitting, by the base station, an SPS scheduling grant comprising a first pattern of the first reference signal and the second reference signal;
transmitting, by the base station, an SPS activation signal;
transmitting, by the base station, a plurality of data channels in the first transmission occasion;
receiving, by the base station, a report of the performance metric;
selecting a second pattern of the first reference signal and the second reference signal based on the reported performance metric; and
transmitting, for a subsequent SPS transmission, a scheduling grant comprising the selected pattern.

33. The method as claimed in claim 29, wherein the request-based downlink MS scheduling comprises:
transmitting, by the base station, an MS grant comprising a first pattern of the first reference signal and the second reference signal for a first MS transmission occasion;
transmitting, by the base station, an MS activation signal;
transmitting, by the base station, a plurality of data channels in the first MS transmission occasion;
receiving, by the base station, a request for an MS grant comprising a second pattern based on the performance metric criterion;
selecting the second pattern of the first reference signal and the second reference signal based on the received request; and
transmitting, for a subsequent MS transmission occasion, an MS grant comprising the selected pattern.

34. The method as claimed in claim 29, wherein the report-based downlink MS scheduling comprises:
transmitting, by the base station, an MS grant comprising a first pattern of the first reference signal and the second reference signal for a first MS transmission occasion;
transmitting, by the base station, an MS activation signal;
transmitting, by the base station, a plurality of data channels in the first MS transmission occasion;
receiving, by the base station, a report of the performance metric;
selecting a second pattern of the first reference signal and the second reference signal based on the reported performance metric; and
transmitting, for a subsequent MS transmission occasion, an MS grant comprising the selected pattern.

35. The method as claimed in claim 28, wherein the request-based CSI acquisition comprises:
transmitting, by the base station in a first CSI acquisition occasion, at least one of the first reference signal and the second reference signal to enable CSI determination;
receiving, from the UE, a feedback message comprising a CSI report and a request for a subsequent CSI reference signal transmission;
selecting, for a subsequent CSI acquisition occasion, one of the first reference signal, the second reference signal, or no reference signal based on the received request; and
transmitting, by the base station in the subsequent CSI acquisition occasion, the selected one of the first reference signal, the second reference signal, or no reference signal.

36. The method as claimed in claim 28, wherein the report-based CSI acquisition comprises:
transmitting, by the base station in a first CSI acquisition occasion, at least one of the first reference signal and the second reference signal to enable CSI determination;
receiving, from the UE, a feedback message comprising a CSI report and a reported performance metric;
selecting, for a subsequent CSI acquisition occasion, one of the first reference signal, the second reference signal, or no reference signal based on the reported performance metric; and
transmitting, by the base station in the subsequent CSI acquisition occasion, the selected one of the first reference signal, the second reference signal, or no reference signal.

37. A method of uplink reference signal transmission in a wireless communication system, the method comprising:
receiving, by the UE, a plurality of configuration parameters for transmitting a first reference signal using a plurality of active ports and transmitting a second reference signal on a subset of the plurality of active ports;
transmitting, by the UE, a first uplink transmission comprising at least one of the first reference signal and the second reference signal in a first transmission occasion;
receiving, by the UE, an indication from a base station for transmitting at least one of the first reference signal and the second reference signal for a subsequent transmission occasion; and
transmitting, by the UE, a subsequent uplink transmission comprising at least one of the first reference signal and the second reference signal in the subsequent transmission occasion based on the indication.

38. The method as claimed in claim 37, wherein the configuration parameters include settings for at least one of an uplink dynamic scheduling, an uplink configured grant (CG), and a CSI acquisition using a sounding reference signal (SRS).

39. The method as claimed in claim 38, wherein for the uplink dynamic scheduling, the method comprises:
transmitting, by the UE, a scheduling request for the first uplink transmission occasion;
receiving, by the UE, a first uplink grant indicating one of the first reference signal and the second reference signal for the first transmission occasion;
transmitting the first uplink transmission using one of the indicated first reference signal and second reference signal;
transmitting, by the UE, a scheduling request for the subsequent transmission occasion;
receiving, by the UE, a second uplink grant indicating one of the first reference signal and the second reference signal for the subsequent transmission occasion; and
transmitting the second uplink transmission using one of the indicated first reference signal and second reference signal.

40. The method as claimed in claim 38, wherein for uplink CG, the method comprises:
receiving, by the UE, a CG configuration comprising a default first pattern for the reference signal transmission;
receiving, by the UE, for a Type 2 CG, an activation signal, wherein the activation signal comprises an optional indication of a second pattern for the reference signal transmission;
determining, by the UE, the pattern for a given CG transmission occasion to be: the second pattern, if the second pattern is indicated in the activation signal; or the default first pattern, if the second pattern is not indicated; and
transmitting, by the UE, the uplink transmission comprising the reference signal corresponding to the pattern on a configured resource.

41. The method as claimed in claim 40, wherein the second pattern is a pattern indicated by the base station based on a performance metric of a prior uplink transmission.

42. The method as claimed in claim 38, wherein the CSI acquisition using SRS comprises:
receiving, by the UE, an SRS configuration comprising a default reference signal for an initial transmission, wherein the configuration defines parameters for the first reference signal and the second reference signal;
transmitting, by the UE, the default reference signal for CSI acquisition in the first transmission occasion;
receiving, by the UE, an indication for one of the first reference signal and the second reference signal for a subsequent transmission occasion; and
transmitting, by the UE, one of the indicated first reference signal and second reference signal for CSI acquisition in the subsequent transmission occasion.

43. A method of uplink reference signal reception at a base station (BS) in a wireless communication system, the method comprising:
transmitting, by the BS, a plurality of configuration parameters for transmitting a first reference signal using a plurality of active ports and transmitting a second reference signal on a subset of the plurality of active ports;
receiving, by the BS, a first uplink transmission comprising at least one of the first reference signal and the second reference signal in a first transmission occasion;
evaluating, by the BS, a performance on the first uplink transmission;
determining one or more of the first reference signal and the second reference signal based on the evaluation; and
transmitting, by the BS, an indication of one or more of the first reference signal and the second reference signal for a subsequent transmission occasion.

44. The method as claimed in claim 43, wherein the configuration parameters include settings for at least one of an uplink dynamic scheduling, an uplink configured grant (CG), and a CSI acquisition using a sounding reference signal (SRS).

45. The method as claimed in claim 44, wherein for the uplink dynamic scheduling, the method comprises:
receiving, by the BS, a scheduling request for the first uplink transmission occasion;
transmitting, by the BS, a first uplink grant indicating one of the first reference signal and the second reference signal for the first transmission occasion;
receiving the first uplink transmission using one of the indicated first reference signal and the second reference signal;
receiving, by the BS, a scheduling request for the subsequent transmission occasion; and
transmitting, by the BS, a second uplink grant indicating one of the first reference signal and the second reference signal for the subsequent transmission occasion.

46. The method as claimed in claim 44, wherein for uplink CG, the method comprises:
transmitting, by the BS, a CG configuration comprising a default first pattern for the reference signal transmission; and
transmitting, by the BS, for a Type 2 CG, an activation signal, wherein the activation signal comprises an optional indication of a second pattern for the reference signal transmission.

47. The method as claimed in claim 46, wherein the second pattern is a pattern indicated by the base station based on a performance metric of a prior uplink transmission.

48. The method as claimed in claim 44, wherein the CSI acquisition using SRS comprises:
transmitting, by the BS, an SRS configuration comprising a default reference signal for an initial transmission, wherein the configuration defines parameters for the first reference signal and the second reference signal;
receiving, by the BS, the default reference signal for CSI acquisition in the first transmission occasion; and
receiving, by the BS, in the subsequent transmission occasion, the one of the first reference signal and the second reference signal transmitted by the UE in response to the indication.
